(19) United States
(12) Patent Application Publication
(10) Pub. No.: US 2025/0108317 A1
(43) Pub. Date: Apr. 3, 2025

(54) CRYOGENIC CLEANING DEVICE

(71) Applicant: FEI Company, Hillsboro, OR (US)

(72) Inventors: Jan Lásko, Brno (CZ); Libor Novák, Brno (CZ); Kamil Bencko, Brno (CZ)

(73) Assignee: FEI Company, Hillsboro, OR (US)

(21) Appl. No.: 18/480,458

(22) Filed: Oct. 3, 2023

(51) Int. Cl. B01D 8/00; F04B 37/08

(52) U.S. Cl. CPC B01D 8/00; F04B 37/08

(57) ABSTRACT

Cryogenic cleaning devices comprise a body and an attachment element for attaching the body to a vacuum chamber to provide a fluid path between the body and the vacuum chamber. A surface is configured to accumulate gas molecules received into the body via the fluid path by condensing and/or adsorbing the gas molecules on the surface when cooled and a single-stage refrigeration system is configured to cool the surface. A pump is configured to pump out the accumulated gas molecules during baking of and a valve is moveable between a first position in which the fluid path is open to allow the gas molecules to be evacuated from the vacuum chamber into the body, and a second position in which the fluid path is closed to prevent the gas molecules from being received into the body.

### FIELD

The disclosure relates generally to systems and methods for cleaning analytical instruments, particularly in analytical instruments comprising a vacuum chamber.

### BACKGROUND

A clean vacuum chamber is useful for analytical instruments in order to be able to reach a desired pressure quickly when the chamber is pumped down. A clean vacuum chamber is also desirable in order to provide good quality measurements (including images) when operating an analytical instrument. For example, a clean SEM vacuum chamber can increase the resolution and accuracy of images produced by an SEM system. Furthermore, a clean SEM vacuum chamber can reduce the amount of system maintenance required.

Water (including water vapour and ice) is a common contaminant in vacuum chambers. This may particularly be the case in high vacuum and lower vacuum chambers, in which the vacuum requirements may not be as stringent as in chambers configured to provide ultra-high vacuum (UHV) or extreme-high vacuum (XHV) conditions. Thus, in high vacuum and lower vacuum chambers, ambient air (including water vapour) may leak into the vacuum chamber—for example, via weak sealings in the vacuum chamber.

When water or ice is present on a surface of a sample during observation, this can affect results obtained by the analytical instrument. For example, the signal of an emitted electron may be influenced by a layer of water on a sample surface. Also, samples sensitive to oxidation (such as, for example, battery samples or (metal) samples heated on a heating stage in a vacuum chamber) can be oxidized by the residual water. Furthermore, any water or ice in or on the sample can change the structure of the sample. For any one or more of these reasons, accurate data may not be easily obtainable. It is therefore desirable to be able to remove water and other contaminants from vacuum chambers in order to be able to obtain useful results.

Certain parts of the analytical instrument and/or vacuum system often prevent direct baking of the vacuum chamber or analytical instrument to remove contaminants. For example, a column may include electronics that preclude heating the analytical instrument above 80° C. Therefore, cleaning devices may be used to decontaminate a vacuum chamber.

A cryogenic pump (also referred to herein as a cryopump) is one such device that can be used to remove contamination from a vacuum chamber. A cryopump is a vacuum pump that traps gases and vapours received into the cryopump by condensing the gases or vapours on a cold surface. As the quantity of condensed gas on the surface approaches saturation, the ability of the surface to collect gas molecules is reduced. The cryopump is therefore regenerated by heating the cryopump, allowing the trapped gases to be released through a pressure relief valve.

However, cryopumps are large and expensive, owing in part to the two-stage refrigeration system required to cool the surface to very low temperatures (20 K or less). The size of the cryopump may mean that it cannot easily be used with certain analytical equipment, as there is not sufficient space to attach the cryopump to the analytical instrument. Furthermore, in low vacuum conditions, saturation of the surface occurs very quickly. For these reasons, cryopumps are typically only used for ultra-high vacuum conditions, especially because other instruments, which may also be smaller in size, may be capable of providing high vacuum conditions at lower cost.

Cryopump operation may also result in large vibrations, making it unsuitable for many applications without additional equipment. For example, cryopumps cannot usually be used with standard SEM systems without additional equipment to isolate the vibrations (as the vibrations would degrade the performance and resolution of the SEM system). This additional equipment can be expensive and there may not be any straightforward way to connect the additional equipment to standard analytical instruments that do not typically implement cryopumps.

Overcoming the issues noted above is desirable.

### SUMMARY

Against this background, there is provided a cryogenic cleaning device, system and method for removing or reducing contamination in an analytical instrument as described in the independent claims. Additional aspects appear in the description and claims.

The methods described herein may be implemented by a controller configured to operate a system comprising a cryogenic cleaning device and an analytical instrument, the analytical instrument comprising a vacuum chamber. Similarly, the methods described herein may be implemented in a system comprising a cryogenic cleaning device, an analytical instrument and a controller configured to operate the cryogenic cleaning device and/or the analytical instrument.

The methods described above may be implemented as a computer program comprising instructions to operate a computer or computer system (or other hardware and/or software configured to implement the method). The computer program may be stored on a computer-readable medium (for example, a non-transitory computer-readable medium).

The computer system may include a processor, such as a central processing unit (CPU), for example. The processor may execute logic in the form of a software program. The computer system may include a memory including a volatile and/or non-volatile storage medium. Different parts of the system may be connected using a network (for example, wireless networks and wired networks). The computer system may include one or more interfaces. The computer system may contain a suitable operating system such as UNIX (including Linux) or Windows (®), for example.

It should be noted that any feature described herein may be used with any particular aspect or embodiment of the invention. Moreover, the combination of any specific apparatus, structural or method features is also provided, even if that combination is not explicitly detailed.

The invention will now be described with reference to the attached drawings depicting different embodiments thereof, the drawings being provided purely by way of example and not limitation.

### BRIEF DESCRIPTION OF DRAWINGS

The invention may be put into practice in a number of ways, and preferred embodiments will now be described by way of example only and with reference to the accompanying drawings, in which:

FIG. 1 schematically illustrates an exemplary system comprising a cryogenic cleaning device and an analytical instrument, the analytical instrument comprising a vacuum chamber and being connected to the cryogenic cleaning device via a fluid path including a valve;

FIG. 2 schematically illustrates a further exemplary system comprising a cryogenic cleaning device and an analytical instrument, the analytical instrument comprising a vacuum chamber;

FIG. 3 shows a flowchart of a method for reducing contamination in a vacuum chamber of an analytical instrument;

FIG. 4 shows a schematic diagram of an exemplary system comprising a cryogenic cleaning device and an analytical instrument connected via a fluid path including a gate valve, the cryogenic cleaning device including a cold stage;

FIG. 5A illustrates a schematic diagram of an exemplary system including a detachable connector connected to an analytical instrument;

FIG. 5B illustrates a schematic diagram of an exemplary system including a detachable connector in a retracted position; and

FIG. 5C shows a schematic diagram of an exemplary system including a detachable connector in another retracted position.

It should be noted that the Figures are illustrated in schematic form for simplicity and are not necessarily drawn to scale. Like features are provided with the same (or similar) reference numerals.

### DESCRIPTION OF PREFERRED EMBODIMENTS

The present disclosure provides a cryogenic device for reducing contamination in a vacuum chamber of an analytical instrument, which may also be referred to herein as a (cryogenic) decontamination device or a (cryogenic) cleaning device. Cryogenics is the production and behaviour of materials at very low temperatures and is considered to relate to refrigeration below about 120 K (−153° C.) to distinguish cryogenics from conventional refrigeration. The cryogenic device may therefore be considered as a device configured to operate at cryogenic temperatures (below 120 K).

Since the devices described herein are primarily concerned with reducing water (or water vapour) contamination, the device may also be referred to as a water trap or a water decontamination device. However, other contaminants such as hydrocarbons, for example, may also be removable from a vacuum chamber by the use of a cryogenic device, even when implementing a single-stage refrigeration system.

The device comprises a body and an attachment element for attaching or mounting the body to a vacuum chamber of an analytical instrument to provide a fluid path between the body and the vacuum chamber. A fluid may include a liquid, a gas or any other material capable of flowing. The fluid path may thus also be referred to herein as a gas path. The body may be a bakeable volume of the device. The attachment element may comprise a flange for mounting the body to the vacuum chamber, but it will be appreciated that other attaching or mounting methods may be used.

The device further comprises a surface configured to accumulate gas molecules (or gas particles) received into the body via the fluid path. The surface is configured to collect the gas molecules by condensing and/or adsorbing the gas molecules on the surface when the surface is cooled. Accordingly, the device further comprises a single-stage (cryogenic) refrigeration system configured to cool the surface. The term single-stage refrigeration system as used herein does not comprise a second stage of refrigeration. The device may thus be capable of cooling the surface to a temperature in a range of 60 to 120 K and may thus operate in a temperature range to allow water and hydrocarbon contamination to be removed from the vacuum chamber. The device may be configured to operate at a specified temperature depending on the contaminant to be removed. For example, the device may be controlled to operate at, for example, 80 K or 100 K to remove water vapour from the vacuum chamber of the analytical instrument.

As gas molecules are collected on the cooled surface, the ability of the surface to collect further gas molecules is reduced. In the case of condensation, as the layer of condensed gas molecules increases in thickness, the surface temperature of the condensed layer increases, lowering the condensing speed of the gas molecules. In the case of adsorption (that is, the adhesion of molecules to the surface), as the quantity of adsorbed gas molecules approaches saturation (which may depend on the temperature and pressure of the adsorbed gas molecules), the adsorbing speed of the gas molecules is lowered considerably.

As a result of the adsorbed and/or condensed molecules, the ability of the cryogenic cleaning device to remove contaminants from the vacuum chamber of the analytical instrument is reduced as the quantity of molecules condensed and/or adsorbed on the cooled surface increases. The collected gas molecules must therefore be cleaned out to restore the cleaning device to its original operating ability. This is achieved by baking the device (applying high heat temperature and sometimes vacuum to the device). The accumulated gas molecules thus vaporize or evaporate, allowing the gas molecules to be evacuated from the cleaning device (for example, by the use of a pump during the baking).

In conventional cleaning devices having only a single-stage refrigeration system, baking and pumping out the cleaning device requires the cleaning device to be disconnected from the vacuum chamber. As the conventional cleaning devices are (directly) connected to the vacuum chamber, disconnecting the cleaning device results in a break in the vacuum system. The vacuum conditions of the vacuum chamber are thus not able to be sufficiently maintained. Therefore, cleaning of the device is generally only carried out once the cleaning device has been completely filled with the contaminant (for example, are full of ice due to water vapour removed from the vacuum chamber).

However, as noted above, the cleaning ability of the cleaning device reduces as the cleaning device becomes more filled with contaminant. Thus, the cleaning ability of the device in the later stages of an experiment (or series of experiments) is reduced, which means that it may be more difficult (or even impossible) to maintain the vacuum conditions necessary for experiments or data collection. A lower vacuum may result in poorer data and/or poorer quality images from the analytical instrument and, in the worst case, may prevent any (useful) data being obtained at all.

Furthermore, cleaning out the device may require time and labour that significantly reduces the throughput of experiments and/or imaging due to, for example, the device (or part of it) being removed to be baked. The analytical instrument cannot be used whilst contamination is being removed from the cleaning device, at least because the lack of cleaning device will mean poor results due to a build-up of contamination. In other words, experiments or measurements need to be stopped whilst the device (or part of it) is removed for bake-out.

In contrast, the presently disclosed cleaning device comprises a valve moveable between a first position, in which the fluid path is open to allow the gas molecules to be evacuated from the vacuum chamber into the body, and a second position, in which the fluid path is closed or blocked to prevent the gas molecules from being received into the body. Thus, the valve can be closed to close the fluid path when baking and pumping out the cleaning device. This may allow the vacuum conditions of the connected vacuum chamber to be maintained, which may in turn result in less contamination in the vacuum chamber, since ambient air is not able to enter the vacuum chamber when removing the cleaning device for cleaning, for example. The valve may also allow cleaning to be carried out more regularly, as the cleaning device does not necessarily need to be removed for cleaning and so there may be a reduced risk of breaking vacuum.

Accordingly, the amount of time required to clean out the device may be reduced, since the cleaning device need not only be cleaned out when completely full. Additionally, the vacuum chamber may be able to be cleaned more efficiently, since the effectiveness of the cleaning device may be maintained by regularly evacuating the condensed and/or adsorbed gas molecules. This may allow vacuum chambers having weaker sealings (for example, in vacuum chambers where UHV is not required) such as O-rings, for instance, to be used in a wider range of applications, since contaminants (for instance, water vapour) in such vacuum chambers can be more effectively removed. Similarly, the valve may allow vacuum chambers with one or more openable apertures that may be opened fairly regularly (for example, one or more doors to allow a user to insert samples when setting up an experiment), or vacuum chambers that are otherwise unable to provide sufficient vacuum conditions with conventional cleaners to be used. This may also improve the lifetime of vacuum chambers used in analytical instruments, since the degradation of the vacuum chamber can be overcome by the more efficient cleaning of the cleaning device.

Furthermore, since the closed gas path allows the vacuum in the vacuum chamber to be maintained, the analytical instrument may continue to operate whilst the fluid path is closed. Thus, the throughput of experiments or imaging may be improved.

In addition, the use of an effective cryogenic cleaning device may be enabled without requiring additional equipment—for example, additional equipment to remove vibrations to allow a cryopump to be connected to an SEM vacuum chamber. Thus, the cost and complexity of analytical instrument setup may be reduced.

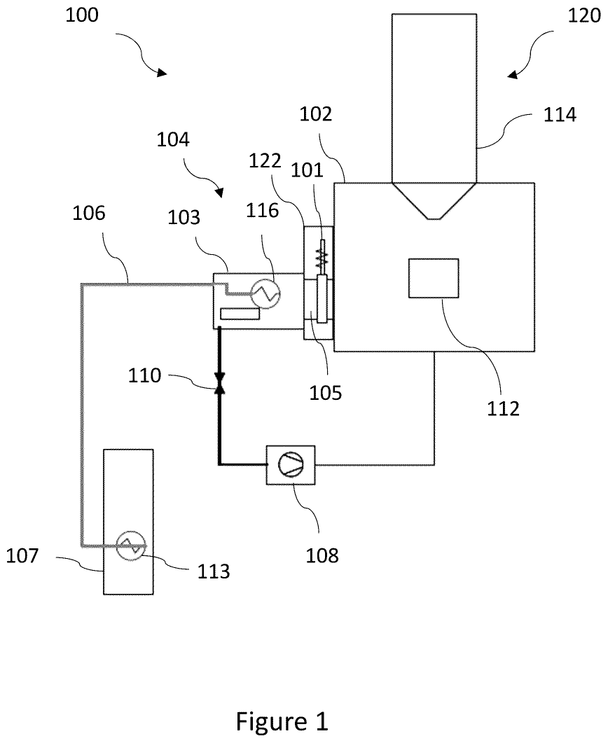

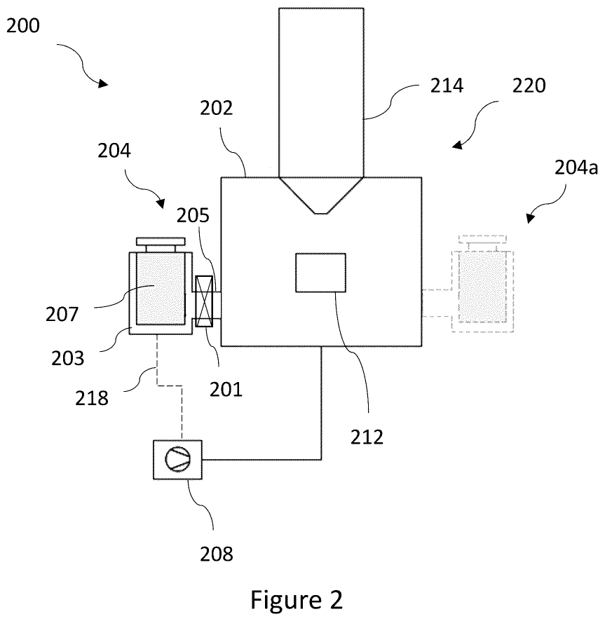

With reference to FIG. 1, an example system 100 comprising a cryogenic cleaning device 104 and an analytical instrument 120 comprising a vacuum chamber 102 connected to the cryogenic cleaning device 104 is shown. The cryogenic cleaning device 104 is attached to the analytical instrument via an attachment element 122. Although only one cryogenic cleaning device 104 is shown in FIG. 1, one or more additional cryogenic cleaning devices 104 may be also included in the system 100, as will be discussed in further detail with reference to FIG. 2. The system may further comprise a controller (not shown) configured to operate the cleaning device 104 and/or analytical instrument 120 in accordance with the methods disclosed herein.

The cryogenic cleaner 104 may comprise an apparatus or component for baking the cleaning device 104, such as a heating element, for example. In other words, the cryogenic cleaner 104 may be bakeable and may comprise an apparatus configured to bake the cryogenic cleaner 104. For instance, the cryogenic cleaner may comprise a resistive heating element 116, as illustrated in FIG. 1. It will be appreciated that another component may be used to bake the cleaning device, in addition to or instead of the resistive heating element 116. For example, the apparatus may comprise a radiative heating element and/or a conductive heating element.

In other examples, the system 100 may comprise a baking apparatus that is distinct from the cryogenic cleaner 104. For example, the baking apparatus may comprise an infra-red lamp to bake the cryogenic cleaning device 104. In another example, the baking apparatus may comprise an oven. In a further example, the baking apparatus may comprise a flexible heating material (for example, a cloth heating jacket). The flexible heating material may comprise resistance wires sewn into an interior liner to provide heat. The flexible heating material may be designed and manufactured to a particular size and configuration based on dimensions of the cryogenic cleaning device 104 to allow surface contact for consistent heat across the area. In yet a further example, the baking apparatus may comprise heat tracing cables or heat tape.

The cryogenic cleaner 104 comprises a valve 101, which may preferably be a gate valve (also known as a sluice valve) or may be another type of valve including a ball valve, a butterfly valve or a plug valve. Other types of valve are possible. The valve 101 allows a fluid path 105 (which may be provided by a channel or pipe in the attachment element 122, as shown in FIG. 1, or by the attachment element 122 itself) between the cryogenic cleaner 104 and the vacuum chamber 102 to be closed to prevent gas molecules being received into a body 103 of the cryogenic cleaner.

The cryogenic cleaner 104 further comprises a single-stage refrigeration system. In the example illustrated in FIG. 1, the single-stage refrigeration system comprises a cryogen storage component 107 arranged outside the body 103 of the cryogenic cleaning device 104 and one or more refrigerant pipes 106 at least partially arranged within the body 103 and connected to the cryogen storage component 107. The cryogen storage component 107 may also be referred to herein as a cryogenic storage vessel 107.

The cryogenic storage component 107 may be or comprise a cryogenic storage dewar (or dewar vessel), a cryogenic storage cylinder or a cryogenic storage tank. A cryogenic storage dewar is a type of vacuum flask configured to store cryogens and may be smaller than, but otherwise functionally similar to, a cryogenic storage cylinder or storage tank. Cryogens typically have boiling points below 120 K, although carbon dioxide and nitrous oxide are often included in the category of cryogens, despite having boiling points above 120 K. Cryogens that may be stored within the storage component 107 may include any one of: nitrogen, hydrogen, helium, argon, oxygen, liquified natural gas (LNG), nitrous oxide, and carbon dioxide. Although the cryogen may typically be a liquified gas (which may also be referred to as a cryogenic liquid) below 120 K, the cryogen may instead be a cryogenic gas held below 120 K but above the cryogen boiling point. Accordingly, cryogens may be referred to herein as cryogenic substances (as opposed to a cryogenic liquid or a cryogenic gas specifically).

In the example shown in FIG. 1, the cryogen storage component 107 includes a heating element 113. In other examples, the cryogen storage component 107 may instead be connected to a heating element. The heating element 113 may be configured to heat the cryogen storage component 107 to the boiling point of the cryogen stored in the cryogen storage component 107. For example, where the cryogen is nitrogen, the cryogen storage component 107 may be heated to the boiling point of nitrogen (approximately 78 K or
−196° C. at atmospheric pressure) and the nitrogen gas maintained at a cool temperature. For example, the nitrogen gas may remain “cooled” at a temperature in the range of −160° C. and −60° C. The nitrogen gas may be cooled to −120° C., for example. The temperature may be selected based on the type of hardware used in the system.

The cold nitrogen gas may be flowed through the one or more refrigerant pipes 106 to cool a surface in the cryogenic cleaning device 104 configured to accumulate gas molecules received into the body 103 via the fluid path 105 by condensing and/or adsorbing the gas molecules on the surface when cooled. In other words, gas molecules are deposited on the cooled surface. Since the gas molecules may be condensed (that is, may form liquid droplets) on the surface, the deposited gas molecules may be referred to as liquid molecules or simply “molecules”.

The cryogenic cleaner 104 further comprises a pump configured to pump out the accumulated gas molecules during baking of the cryogenic cleaning device. In the example illustrated in FIG. 1, the pump comprises a vacuum pump 108 (or series of vacuum pumps) configured to generate a vacuum in the vacuum chamber 102 of the analytical instrument 120. The vacuum pump 108 may be connected to the body 103 via a valve 110. The vacuum pump 108 may comprise a vacuum pump with gas transport (for example, a turbomolecular pump, a scroll pump, an oil diffusion pump, and so on) or with gas entrapment (for example, an ion getter, a cryopump, and so on), or another vacuum pump configured to generate a vacuum. It will be appreciated that in other examples, the pump of the cryogenic cleaner 104 may be a non-vacuum pump and/or may be a pump distinct from the pump configured to generate the vacuum in the vacuum chamber 102 (although the pump may still be a pump of the analytical instrument 120).

The cryogenic cleaning device 104 may be or comprise any device capable of trapping water evacuated from a vacuum chamber. For instance, the cryogenic cleaning device 104 may comprise a cryogenic (or cold) stage configured to trap water. In some analytical instrument applications (for example, cryogenic SEM applications), a cold stage may be used to cool part of the analytical instrument (for example, the vacuum chamber). This may result in water being trapped in the analytical instrument, since the water is frozen by the cold temperatures of the by the cryogenic stage (cryo-stage) and so is unable to be evacuated. This may result in ice in or on the sample, which is undesirable. However, by using a cold stage as a cryogenic cleaning device (external to the vacuum chamber of the analytical instrument), this water-trapping capability can be used to clean the vacuum chamber. That is, even in applications not utilizing cryogenic temperatures, a cold stage may be present in the system.

In some examples, the cold stage may be detachably connected to the analytical instrument 120 or cryogenic cleaning device 104. A cold stage may include one or more pipes or channels to allow a cryogenic substance to flow within the cold stage to allow cryogenic cooling. The cold stage may comprise a cold finger (a piece of equipment configured to generate a localized cold surface and a type of cold trap) and sample holder.

A cold stage may be used for cryogenic SEM applications (also known as low-temperature scanning electron microscopy). Cryogenic SEM (cryo-SEM) may allow analysis of materials not typically possible using conventional SEM methods (for instance, due to conventional preparation techniques such as critical point drying). For example, liquids, biological material and “wet” food products may be analysable using cryo-SEM. Furthermore, cryo-SEM allows specimens to be cold-fractured to reveal internal microstructures that may not be visible using conventional SEM methods.

Additionally or alternatively, the cryogenic cleaning device 104 may comprise a cold trap. A cold trap or cryo-stage may individually be efficient enough to clean the vacuum chamber, but providing both may allow more efficient cleaning. For example, providing both a cold trap and cryo-stage may be useful if a vacuum chamber has already become filled with contaminant such as water, for example.

In some examples, the cold trap may be detachably connected to the cryogenic cleaning device 104. A cold trap is a device configured to condense vapours into a liquid or solid, usually to prevent vapours being evacuated from an experiment from entering a vacuum pump, where they may condense and contaminate the vacuum pump. Similarly to a cold stage, a cold trap may be used in cryo-SEM. However, a cold trap may be present in the system even in cases where cryo-SEM is not used. For example, providing a cold trap in proximity to a cryogenic cleaner may facilitate the cleaning ability of the cryogenic cleaner. Thus, a system arrangement in which a cold trap is connected to a cryogenic cleaner may improve the speed and efficiency of the cryogenic cleaner.

Additionally or alternatively, the decontamination device 104 may comprise a cryogenic transfer system for transferring samples or specimens between sample preparation stations at cryogenic temperatures. Cryogenic transfer systems may prevent or reduce chemical or morphological changes in or destruction of samples (for example, for environmentally- or thermally-sensitive samples) when transferring to a vacuum chamber of an analytical instrument by utilising temperature control and/or operating at cryogenic temperatures. The cryogenic transfer system includes components to allow the transfer system to operate at cryogenic temperatures, which may also be capable of being used to cryogenically clean a vacuum chamber, it may be convenient for use as a cryogenic decontamination device. For example, one or more refrigerant pipes to provide cryogenic temperatures for sample transfer may also be used to cryogenically cool a surface within the system. In other words, the decontamination device 104 may be a cryogenic transfer system.

The analytical instrument 120 illustrated in FIG. 1 comprises a particle beam source 114 directed at a sample 112 in the vacuum chamber 102. The vacuum chamber may be configured to operate under low (also known as rough) vacuum, medium (also known as fine) vacuum, high vacuum or UHV conditions. Operating the chamber 102 under high vacuum conditions may mean that molecules may not have a high probability of colliding with other molecules, and so may form a (substantially) directed beam of molecules. This may be useful for particle beam applications. However, lower vacuum conditions (for example, medium and low vacuum conditions) may be useful in SEM arrangements, for instance, as lower vacuum operation may reduce much of the sample preparation required for high vacuum operation.

The cryogenic cleaning device 104 may be configured to reduce contamination in the vacuum chamber such that the vacuum chamber is configured to operate within a particular vacuum regime. For example, the cryogenic cleaning device 104 may be configured to reduce the contamination in the vacuum chamber such that the vacuum chamber can operate at high vacuum or higher. High vacuum may correlate to a pressure in the range of 1×10⁻⁶ Pa to 0.1 Pa (1×10⁻⁸ mbar to 1×10⁻³ mbar), and ultra-high vacuum may correspond to a pressure in the range of 1×10⁻⁹ Pa to 1×10⁻⁶ Pa (1×10⁻¹¹ mbar to 1×10⁻⁸ mbar), as defined in ISO 3529-1:2019. Rough vacuum may correspond to a pressure in the range of 0.1 Pa to 100 Pa (1×10⁻³ mbar to 1 mbar), while fine vacuum may correspond to a pressure in the range of 100 Pa (1 mbar) to prevailing atmospheric pressure (approximately 31 kPa to 110 kPa, or 310 mbar to 1100 mbar), as also defined in ISO 3529-1:2019. However, it will be appreciated that other pressure ranges may be used, as the pressure range corresponding to a particular vacuum condition may depend on various factors such as dimensions of the vacuum chamber 102, temperature within the vacuum chamber 102, and species of molecule within the vacuum chamber 102, for example. For molecules having a larger collisional cross-section, the pressure in the vacuum chamber 102 may need to be lower than 10⁻³ mbar to avoid or sufficiently reduce collisions. A larger volume vacuum chamber 102 may likewise require a pressure lower than 10⁻³ mbar to sufficiently reduce collisions. Preferably, the pressure range corresponds to operating the vacuum chamber at high or ultra-high vacuum.

The presence of molecular flow (and hence, the high or ultra-high vacuum regime) can be determined in a straightforward and empirically verifiable manner by the Knudsen number. The Knudsen number is a dimensionless number defined as Kn=λ/L, where λ is the mean free path and L corresponds to a physical length, which may be a length of the vacuum chamber in one dimension. At Knudsen numbers greater than 0.5, the probability of molecules colliding may be low or substantially zero, such that the molecular flow may correspond to high vacuum conditions. In some examples, the Knudsen number may more than or equal to 1. In other examples, the Knudsen number may more than or equal to ten, to further reduce the probability of molecular collisions. Molecules may thus be in free molecular flow.

The particle beam source 114 may comprise an electron source, ion source, X-ray source or another source. The analytical instrument 120 may thus be or comprise a particle beam apparatus. For instance, the analytical instrument 120 may be or comprise a scanning electron microscopy (SEM) arrangement, a focused ion beam (FIB) arrangement, an X-ray photoelectron spectroscopy (XPS) arrangement, a transmission electron microscopy (TEM) arrangement or another particle beam apparatus arrangement. In an SEM arrangement, a focused beam of electrons may be used to image a sample 112 in the vacuum chamber 102 by detecting reflected or back-scattered electrons. SEM systems may thus provide information regarding the surface and composition of the sample 112. An FIB arrangement is a similar scientific instrument setup, but using a focused beam of ions instead of electrons. In an XPS arrangement, a beam of X-rays is used to irradiate a sample 112 in a vacuum chamber to obtain electron population spectra. The vacuum chamber in an XPS arrangement may preferably operate at UHV. In a TEM arrangement, a focused beam of electrons may be used to image a sample 112 in the vacuum chamber 102 by detecting electrons transmitted through the sample 112. TEM systems may thus provide information regarding an inner structure of the sample 112 such as, for example, crystal structure, morphology and stress state information.

In some examples, the analytical instrument 120 may comprise more than one particle beam apparatus arrangement—for example, in focused ion beam scanning electron microscopy (FIB-SEM). An FIB-SEM arrangement may allow the sample 112 to be investigated using either or both of the particle beams.

Each of the components may be controlled by a controller (not shown). The controller may comprise a computer that functions as a data processor for receiving data from a detector (for example, an X-ray detector, secondary electron detector, secondary ion detector, and so on). The data may be representative of a distribution and abundance of elements and/or a chemical state of elements in a sample. The computer may also function as a data processor for processing the data to provide an image of the sample. The controller may further comprise a display and user input device so that a user can view and enter or select information. The user input device may comprise a keyboard and/or a mouse.

Referring to FIG. 2, another example system 200 comprising a cryogenic cleaning device 204 and an analytical instrument 220 comprising a vacuum chamber 202 connected to the cryogenic cleaning device 204 is shown. An optional additional cryogenic cleaning device 204a is illustrated, as will be discussed in further detail below, and it will be appreciated that still further cryogenic cleaning devices may be included in the system 200. The system 200 may thus comprise one or more cleaning devices 104, 204. The system 200 may further comprise a controller (not shown) configured to operate the cleaning device 204 and/or analytical instrument 220 in accordance with the methods disclosed herein.

The system 200 is similar in many respects to the system 100 described above with reference to FIG. 1. For example, the cryogenic cleaner 204 comprises a valve 201, which may preferably be a gate valve, to allow a fluid path 205 (which may be provided by a channel or pipe, for example) between the cryogenic cleaner 204 and the vacuum chamber 202 to be closed to prevent gas molecules being received into a body 203 of the cryogenic cleaner. A gate valve is a valve that opens by lifting or moving a barrier out of the path of a fluid.

The cryogenic cleaner 204 further comprises a single-stage refrigeration system. In the example illustrated in FIG. 2, the single-stage refrigeration system comprises a cryogen storage component 207 arranged within the body 203 of the cryogenic cleaning device 204. As discussed with reference to FIG. 1, the cryogenic storage component 207 may be a cryogenic storage dewar (or dewar vessel), a cryogenic storage cylinder or a cryogenic storage tank. Cryogenic substances that may be stored within the storage component 207 may include any one of: nitrogen, hydrogen, helium, argon, oxygen, LNG, nitrous oxide, and carbon dioxide.

In the cryogenic cleaning device 204, the cryogenic storage component 207 is a vessel surrounded by the body 203 of the cryogenic cleaning device 204. The space between the cryogenic storage component 207 and the body 203 is evacuated, which may be achieved by a pump 208 of the analytical instrument 220. The cryogenic storage component 207 is then filled with cryogenic substance (for example, liquid nitrogen) and sealed. In this example, the cryogenic substance does not flow within the body 203, but rather is static.

The cryogenic storage component 207 may include a closeable aperture for refilling the cryogenic storage component 207 with the cryogenic substance. The cryogenic storage component 207 may be removeable from the cryogenic cleaning device 204—for example, to allow removal of condensed contamination. In typical cryogenic cleaning devices, removing the cryogenic storage component may requiring opening the vacuum chamber to ambient air before a lid is placed on the body to seal the vacuum chamber. This may allow contaminants to be introduced into the vacuum chamber and increase the pressure in the vacuum chamber (reduce the vacuum) before the vacuum chamber is sealed again. In contrast, since the presently disclosed cryogenic cleaning device 204 includes a valve 201 that can be used to close the fluid path 205 between the cryogenic cleaning device 204 and the analytical instrument 220, removing the cryogenic storage component may not result in loss of (or a reduction of) vacuum or introduction of contaminants into the vacuum. In some examples, the cryogenic cleaning device 104, 204 may be removeable (rather than the cryogenic storage component 207 specifically).

Since the cryogenic storage component in this example is arranged within the body of the cryogenic cleaning device 204, the size of the cryogenic cleaning device 204 can be reduced compared to other cryogenic cleaning devices (as, for example, the cryogenic cleaning device 204 need not include one or more refrigerant pipes). Thus, a smaller volume cryogenic cleaning device may be used with the analytical instrument, whilst still providing sufficient contamination reduction in the vacuum chamber of the analytical instrument 220. The gas path 205 may accordingly be shorter than in other embodiments to reduce the overall system size.

In the example illustrated in FIG. 2, the cryogenic cleaning device 204 does not include a baking apparatus or component. Instead, the system 200 may further comprise a baking apparatus to be used with the cryogenic cleaning device 204. As described with respect to FIG. 1, the apparatus for baking the cleaning device 204 may comprise a heating element. For example, the baking apparatus may comprise an infra-red lamp, an oven, a flexible heating material or heat tracing cables. In other examples, the cryogenic cleaning device 204 may include an integrated baking component such as, for example, an integrated heating element.

The system 200 further comprises a pump configured to pump out the accumulated gas molecules during baking of the cryogenic cleaning device. In the example illustrated in FIG. 2, the pump comprises a vacuum pump 208 configured to generate a vacuum in the vacuum chamber 202 of the analytical instrument 220. Optionally, the vacuum pump 208 may be connected to the cryogenic cleaning device 204 via fluid path 218. The vacuum pump 208 may thus be configured to evacuate the volume of the cryogenic cleaning device 204 (during bake-out, for instance). The fluid path 205 can be closed by the use of the valve 201 (which may be, for example, a gate valve) during such a bake-out, as described herein. It will be appreciated that in other examples, the pump may be a non-vacuum pump and/or may be a pump distinct from the pump 208 of the analytical instrument 220 that is configured to generate the vacuum in the vacuum chamber 202.

The analytical instrument 220 illustrated in FIG. 2 comprises a particle beam source 214 directed at a sample 212 in the vacuum chamber 202. The particle beam source 214 may be as described with reference to FIG. 1. For instance, the particle beam source 214 may be an electron, ion or X-ray source and the analytical instrument 220 may accordingly be or comprise a scanning electron microscope (SEM) arrangement, a focused ion beam (FIB) arrangement, or an X-ray photoelectron spectroscopy (XPS) arrangement. In some examples, the particle beam source 214 may comprise more than one source—for example, in a focused ion beam scanning electron microscopy (FIB-SEM) arrangement.

As discussed above, the system may comprise an additional device for reducing contamination 204a. FIG. 2 illustrates the additional device 204a as being the same type of device as the cryogenic cleaning device 204. The additional device 204a may thus have the same components or similar types of component as the cryogenic cleaning device 204 and may be attached to the analytical instrument 220 in the same or a similar manner. In other examples, the additional device 204a may be a different type of cleaning device. For example, the cleaning device 104 described with reference to FIG. 1 or another cleaning device may be used. In another example, a cryogenic pump may be attached to the analytical instrument 220. In other words, in cases where the system comprises more than one decontamination device 204, each of the decontamination devices 204 may be of the same type or some or all of the decontamination devices 204 may be of different types.

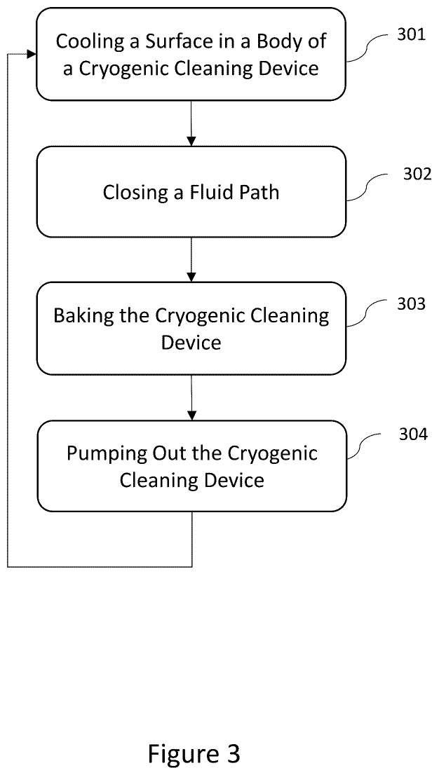

Including two or more decontamination devices in the system may further improve the throughput of experiments or the contamination reduction in the vacuum chamber. For example, whilst a single decontamination device allows more regular cleaning of the vacuum chamber without losing vacuum conditions (as will be discussed further in respect of FIG. 3), it still may take some time to clean out the decontamination device. By using two or more decontamination devices, in which at least one decontamination device includes a valve, one decontamination device can remain operative and connected to the vacuum chamber for reducing contamination in the chamber whilst the other decontamination device is baked and pumped out.

With reference to FIG. 3, there is shown a flowchart of a method for reducing contamination in a vacuum chamber of an analytical instrument. The method may be implemented in any of the systems or devices discussed herein.

At step 301, a surface in a body of a cryogenic cleaning device is cooled using a single-stage refrigeration system. Cooling the surface allows gas molecules received into the body via a closeable gas path to accumulate on the cooled surface via condensation and/or adsorption. In conventional cryogenic cleaning devices, accumulating sufficient molecules on the surface to sufficiently reduce contamination in the vacuum chamber may take more than five hours (typically being around ten hours). However, according to the devices and systems described herein, the duration of step 301 may be less than ten hours or less than five hours to sufficiently reduce contamination in the vacuum chamber.

The fluid path is closed in step 302 to prevent further gas molecules from being received into the body, after a number of gas molecules have been accumulated on the cooled surface. The fluid path may be closed by the use of a valve configured to block the fluid path. The valve may be a gate valve, a ball valve, a butterfly valve, a plug valve or another type of valve. In some examples, the valve may comprise a series of valves and one or more of the series of valves may be closed. In cases where the valve comprises a series of valve, some or all of the series of valves may be different types of valves.

At step 303, after closing the fluid path, the cryogenic cleaning device is baked. Baking the device may comprise heating the device to a temperature of 80° C. or higher. For example, the device (or part of the device, such as, for example, a cryogenic storage component) may be heated to a temperature in a range of 90° C. to 120° C. The device may be baked for at least several minutes (for instance, at least two minutes, at least five minutes, at least ten minutes, at least twenty minutes or longer). The device may typically be baked for around two hours.

At step 304, the cryogenic cleaning device is pumped out to remove the gas molecules that had been accumulated on the cooled surface from the cryogenic cleaning device. Pumping out the cleaning device may occur during the baking or may occur subsequent to the baking.

After pumping out the cryogenic cleaning device, the fluid path may be opened to allow further gas molecules to be accumulated in the cryogenic cleaning device. For instance, when the cryogenic cleaning device is fresh (the deposited contamination has been removed) and has been cooled to cryogenic temperatures again, the fluid path may be opened. The fluid path may be opened by opening or moving a valve.

Thus, after step 304, the method may return to step 301 to repeat steps 301-304. According to the devices and systems described herein, a cleaning cycle (steps 301-304) may be performed more regularly than using conventional cleaning devices and this may be performed without breaking vacuum conditions in the vacuum chamber. For example, a cleaning cycle may be performed less than every fifteen hours. More specifically, a cleaning cycle may be performed every hour, every five hours or every ten hours, for example. In other examples, cleaning cycles may be performed more regularly. In short, the devices and systems described herein may allow continuous, pseudo-continuous or near-continuous cleaning of the vacuum chamber, as the fluid path can be closed at any time without breaking the vacuum of the vacuum chamber. Since the closed gas path allows the vacuum in the vacuum chamber to be maintained, the analytical instrument may continue to operate whilst the fluid path is closed. Thus, the throughput of experiments or imaging may be improved.

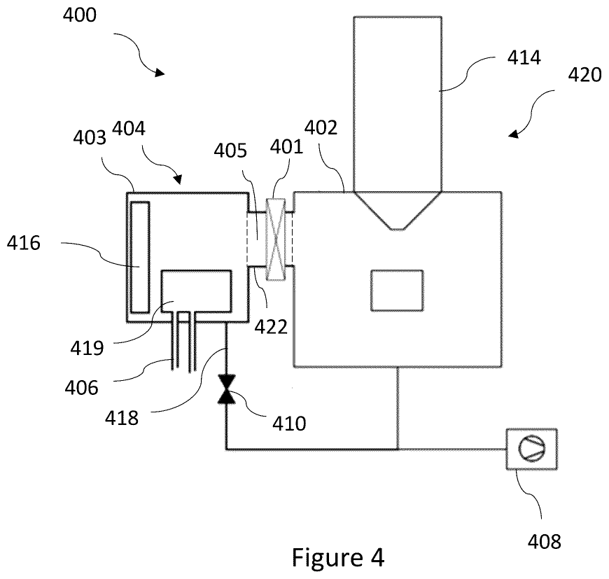

FIG. 4 illustrates a schematic diagram of a system 400 comprising a cryogenic cleaning device 404 and an analytical instrument 420 comprising a vacuum chamber 402. The system 400 illustrated in FIG. 4 is similar in many respects to those illustrated in FIGS. 1 and 2. Any of the components and/or configurations discussed in respect of FIGS. 1 and 2 may be present in the embodiment illustrated in FIG. 4, even if not explicitly described with reference to FIG. 4. For example, the analytical instrument 420 includes a particle beam source 414, which may include any one or more of the particle beam sources discussed herein or another particle beam source.

In the system 400 illustrated in FIG. 4, the cryogenic cleaning device 404 comprises a heating element 416 for baking the cryogenic cleaning device. The heating element 416 may be arranged within the bakeable volume of the cryogenic cleaning device 404, as shown in FIG. 4, or may be connected to, but outside the body 403 of, the cryogenic cleaning device 404. It will be appreciated that, in other examples, the heating element 416 may not be present in or connected to the cryogenic cleaner 404 and a separate baking apparatus may be used to bake the cleaning device 404.

The cryogenic cleaning device 404 further comprises a cold stage 419 connected to a cryogenic storage component (not shown) arranged outside the body 403 of the cryogenic cleaning device 404 via two refrigerant pipes 406. In other examples, a different number of refrigerant pipes may be provided.

In FIG. 4, the cryogenic cleaning device 404 is connected to a vacuum pump 408 configured to create a vacuum in chamber 402 via fluid channel 418. Thus, as discussed with reference to FIG. 2, the vacuum pump 408 may be configured to evacuate the volume of the cryogenic cleaning device 404 during bake-out, for example. The fluid channel 418 is closeable via valve 410. In other examples, another pump of the analytical instrument or a separate pump may be configured to evacuate the volume of the cryogenic cleaning device 404 during bake-out.

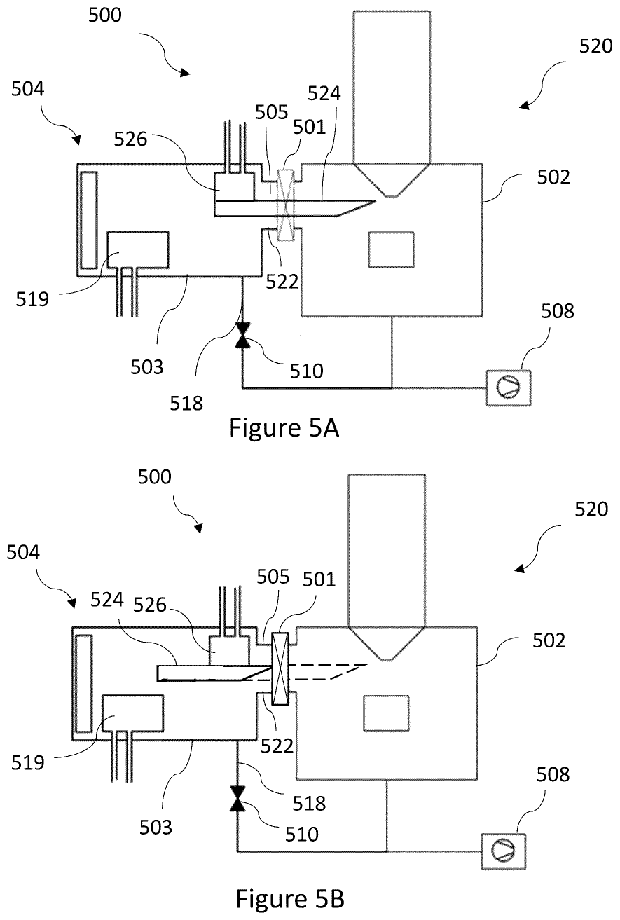

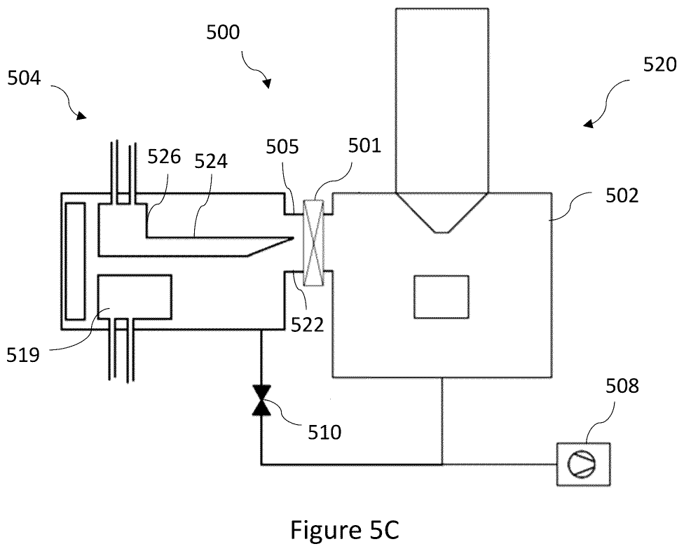

The system 400 comprises an attachment 422 providing a fluid path 405 between the cryogenic cleaning device and the analytical instrument 420 via pipe or channel, the fluid path 405 being closeable via a gate valve 401. The attachment 422 may also allow a cryogenic (or cold) stage and/or cold trap to be connected to or inserted into the analytical instrument 420. In some examples, the cold trap and/or cold stage may be retractably attached to the analytical instrument 420, as will be discussed with reference to FIGS. 5A to 5C.

Using a cold trap in combination with the cryogenic cleaning device may improve the ability of the cryogenic cleaner to evacuate water vapour or other contaminants from the vacuum chamber. However, the cold trap may not always be in use (for example, when not using cryo-SEM). When not in use, the cold trap may take up space that could be used for other equipment. Furthermore, the cold trap may not be bakeable, which may prevent the cryogenic cleaner from being baked, or at least make it more difficult, time consuming and/or expensive to bake the cryogenic cleaner. For example, additional equipment may be required, the cryogenic cleaner may need to be redesigned, or only certain types of cryogenic cleaner may enable baking. Thus, it is useful to be able to detachably connect a cold trap to the cryogenic cleaning device.

FIGS. 5A, 5B and 5C show schematic diagrams of a system 500 including a cryogenic cleaning device 504 and an analytical instrument 520 comprising a vacuum chamber 502, illustrating a detachable connector 524 for detachably connecting a cold stage and/or cold trap to the vacuum chamber 502. The cold stage and/or cold trap may be connected to the vacuum chamber 502 in one of a variety of ways.

FIG. 5A illustrates a cryogenic cleaning device 504 comprising a cold trap 526. The cold trap 526 in this example is arranged within the body 503 of the cryogenic cleaning device 504, but in other examples, the cold trap 526 may be connected to the cryogenic cleaning device 504 but located outside of the body 503. The cold trap 526 comprises the detachable connector 524.

FIG. 5A illustrates the cold trap 526 when the detachable connector 524 has been inserted into the analytical instrument 520. Inserting the detachable connector 524 into the analytical instrument 520 may comprise attaching the detachable connector 524 to the analytical instrument 520 or a component of the analytical instrument (for example, the vacuum chamber 502). The detachable connector 524 may be inserted into the analytical instrument 520 during cleaning (that is, whilst the cryogenic cleaner is operating to remove or reduce contamination in the vacuum chamber of the analytical instrument 520).

FIG. 5B shows the detachable connector 524 when detached or disconnected from the analytical instrument 520. The detachable connector 524 may be detached from the vacuum chamber during baking and/or pumping out of the cryogenic cleaning device 504. In cases where the cold stage remains arranged within the cryogenic cleaning device 504 when detached from the vacuum chamber, the cold stage may thus be baked and/or pumped out when the cryogenic cleaning device is baked and/or pumped out after closing the gate valve 501. Thus, contamination in the cold stage (or cold trap) can be removed in a straightforward manner.

In the exemplary system shown in FIG. 5B, the detachable connector 524 is retracted to detach the detachable connector 524 from the analytical instrument 520 (and thus may also be referred to as a retractable connector 524). In other examples, the cold stage (or cold trap) may be moveable to detach the cold stage from the vacuum chamber of the analytical instrument (although the cryogenic cleaning device may remain attached to the analytical instrument). One such exemplary embodiment is shown in FIG. 5C. In any of these cases, the cold stage may remain arranged within the cryogenic cleaning device 504 when detached from the vacuum chamber. In another example, the cold stage (or cold trap) may be moveable to detach the cold stage from the cryogenic cleaning device. In these examples, a detachable connector 524 may still be present, but it may not be retractable.

As shown in FIG. 5B, the retractable connector 524 when retracted may be housed at least partially in an attachment component 522 that provides a fluid path 505 between the cryogenic cleaning device and the analytical instrument 520. Valve 501 for closing the fluid path 505 may be provided within the attachment 522 such that the valve 501 is closeable when the retractable connector 524 is retracted and at least partially housed within the attachment 522.

When the retractable connector 524 is partially housed within the attachment component 522, the retractable connector 524 may be also at least partially housed within the body 503 of the cleaning device 504. In some examples, the attachment component 522 may be dimensioned such that the retractable connector 524 can be fully housed within the attachment component 522 when not in use. In other examples, the retractable connector may be housed fully within the body 503.

As discussed with reference to FIGS. 2 and 4, the cryogenic cleaning device 504 is connected to a vacuum pump 508 that is configured to create a vacuum in chamber 502 via fluid channel or path 518. The fluid path 518 may be closeable via valve 510. In some examples, the cryogenic cleaning device 504 may be connected to the vacuum pump 508 via the attachment component 522, which may comprise one or more apertures for connecting to a (vacuum) pump. In some examples, fluid path 518 may not be present and a separate (vacuum) pump may be connected to the cryogenic cleaning device 504—for instance, via the one or more apertures of the attachment component 522.

FIG. 5C illustrates an exemplary embodiment, in which the cold stage 526 is moveable to detach the detachable connector 524 from the vacuum chamber 502. In FIG. 5C, the cold stage 526 is in a retracted position (where FIG. 5A illustrates an exemplary attached position).

Standard cryopumps are unable to be connected to a cold trap, and this would especially be the case for a moveable cold trap. Enabling a cryopump to be connected to a cold trap would require a significant and expensive hardware redesign. As many analytical instrument applications do not require the extreme low temperatures provided by a cryopump and cryopumps may be disadvantageous to use for the reasons discussed herein (for example, their large size, their operation causing vibrations, and so on), providing a single-stage refrigeration cryogenic cleaning device capable of attaching to a cold trap may be advantageous.

Although FIGS. 5A to 5C are described with reference to a cold stage 526 comprising a retractable connector 524, wherein the cold stage 526 is optionally moveable, it will be appreciated that, additionally or alternatively, cold trap 519 may comprise a detachable and/or retractable connector and may optionally be moveable. In these examples, the cold stage 526 may not be present (for example, as illustrated in FIG. 4).

The systems illustrated in FIGS. 5A to 5C may be similar in many respects to the systems described with reference to FIGS. 1, 2 and 4. Any of the components and/or configurations discussed in respect of FIGS. 1, 2 and 4 may be present in the embodiment illustrated in FIGS. 5A to 5C, even if not explicitly described.

The methods described herein may be implemented with computer system configurations including hand-held devices, microprocessor systems, microprocessor-based or programmable consumer electronics, minicomputers, mainframe computers and the like. The embodiments can also be practiced in distributed computing environments, where tasks are performed by remote processing devices that are linked through a network.

The computer system may include a processor, such as a central processing unit (CPU). The processor may execute logic in the form of a software program. The computer system may include a memory including volatile and non-volatile storage medium. The different parts of the system may be connected using a network (for example, wireless networks and wired networks). The computer system may include one or more interfaces. The computer may contain a suitable operating system such as UNIX (including Linux) or Windows (®), for example.

Certain embodiments can also be embodied as computer-readable code on a non-transitory computer-readable medium. The computer readable medium may be any data storage device than can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion. Although embodiments according to the disclosure have been described with reference to particular types of devices and applications (particularly mass spectrometers) and the embodiments have particular advantages in such case, as discussed herein, approaches according to the disclosure may be applied to other types of device and/or application. The specific calibration details of the cryogenic cleaning devices and/or system, whilst potentially advantageous (especially in view of known calibration constraints and capabilities), may be varied significantly to arrive at devices with similar or identical operation. Each feature disclosed in this specification, unless stated otherwise, may be replaced by alternative features serving the same, equivalent or similar purpose. Thus, unless stated otherwise, each feature disclosed is one example only of a generic series of equivalent or similar features.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. For example, a system comprising a cryogenic cleaner and an analytical instrument comprising a vacuum chamber may comprise any one or more of the cryogenic cleaners and/or analytical instruments described herein. Likewise, features described in non-essential combinations may be used separately (not in combination). It will be appreciated that there is an implied “about” prior to temperatures, concentrations, times, pressures, flow rates, cross-sectional areas, voltages, currents, etc. discussed in the present teachings, such that slight and insubstantial deviations are within the scope of the present teachings. Furthermore, values referred to as being “equal” may in fact differ by less than a threshold amount. The threshold amount may be 5%, for example. The threshold may also be greater than 5% (e.g., 10%, 20% or 50%) or less than 5% (for example, 2% or 1%), depending on the context.

As used herein, including in the claims, unless the context indicates otherwise, singular forms of the terms herein are to be construed as including the plural form and vice versa. For instance, unless the context indicates otherwise, a singular reference herein including in the claims, such as “a” or “an” (such as a decontamination device) means “one or more” (for instance, one or more decontamination devices).

Throughout the description and claims of this disclosure, the words “comprise”, “including”, “having” and “contain” and variations of the words, for example “comprising” and “comprises” or similar, mean “including but not limited to”, and are not intended to (and do not) exclude other components. Also, the use of “or” is inclusive, such that the phrase “A or B” is true when “A” is true, “B is true”, or both “A” and “B” are true. Furthermore, the use of bracketed terms (terms in parentheses) may be inclusive, such that the phrase “(C) D” is true when “D” is true”, or both “C” and “D” are true. For example, the term “(vacuum) pump” may mean “vacuum pump” or “pump”. In other cases, the use of bracketed terms may indicate optional language in the term, such that the phrase “(C) D” may mean that an element can be referred to as “D” or “(C) D”. For example, the term “(cryogenic) cleaning device” may mean that the component may be referred to herein as a “cryogenic cleaning device” or a “cleaning device”.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

The terms “first” and “second” may be reversed without changing the scope of the invention. That is, an element termed a “first” element (e.g., a first position) may instead be termed a “second” element (e.g., a second position) and an element termed a “second” element (e.g., a second position) may instead be considered a “first” element (e.g. a first position).

Any steps described in this specification may be performed in any order or simultaneously unless stated or the context requires otherwise. Moreover, where a step is described as being performed after a step, this does not preclude intervening steps being performed.

It is also to be understood that, for any given component or embodiment described herein, any of the possible candidates or alternatives listed for that component may generally be used individually or in combination with one another, unless implicitly or explicitly understood or stated otherwise. It will be understood that any list of such candidates or alternatives is merely illustrative, not limiting, unless implicitly or explicitly understood or stated otherwise.

In this detailed description of the various embodiments, for the purposes of explanation, numerous specific details are set forth to provide a thorough understanding of the embodiments disclosed. One skilled in the art will appreciate, however, that these various embodiments may be practiced with or without these specific details. Furthermore, one skilled in the art can readily appreciate that the specific sequences in which methods are presented and performed are illustrative and it is contemplated that the sequences can be varied and still remain within the scope of the various embodiments disclosed herein.

All literature and similar materials cited in this application, including but not limited to patents, patent applications, articles, books, treaties and internet web pages are expressly incorporated by reference in their entirety for any purpose. Unless otherwise described, all technical and scientific terms used herein have a meaning as is commonly understood by one of ordinary skill in the art to which the various embodiments described herein belongs.

1. A cryogenic cleaning device comprising:
a body and an attachment element for attaching the body to a vacuum chamber of an analytical instrument to provide a fluid path between the body and the vacuum chamber;
a surface configured to accumulate gas molecules received into the body via the fluid path by condensing and/or adsorbing the gas molecules on the surface when cooled;
a single-stage refrigeration system configured to cool the surface;
a pump configured to pump out the accumulated gas molecules during baking of the cryogenic cleaning device; and
a valve moveable between a first position in which the fluid path is open to allow the gas molecules to be evacuated from the vacuum chamber into the body, and a second position in which the fluid path is closed to prevent the gas molecules from being received into the body.

2. The cryogenic cleaning device of claim 1, wherein the valve comprises one or more of: a gate valve, a ball valve, a butterfly valve and a plug valve.

3. The cryogenic cleaning device of claim 1, wherein the single-stage refrigeration system comprises a cryogen storage component arranged within the body or the single-stage refrigeration system comprises a cryogen storage component arranged outside the body and one or more refrigerant pipes at least partially arranged within the body and connected to the cryogen storage component.

4. The cryogenic cleaning device of claim 3, wherein the cryogen storage component comprises a cryogen selected from: nitrogen, hydrogen, helium, argon, oxygen, liquified natural gas (LNG), nitrous oxide, and carbon dioxide.

5. The cryogenic cleaning device of claim 1, wherein the cryogenic cleaning device comprises a cold stage, a cold trap, a cryogenic storage device and/or a cryogenic transfer system.

6. The cryogenic cleaning device of claim 1, wherein the gas molecules comprise water molecules.

7. The cryogenic cleaning device of claim 1, wherein the analytical instrument comprises a particle beam apparatus.

8. The cryogenic cleaning device of claim 7, wherein the particle beam apparatus comprises one or more of: a scanning electron microscopy (SEM) arrangement, a focused ion beam (FIB) arrangement, an X-ray photoelectron spectroscopy (XPS) arrangement and a transmission electron microscopy (TEM) arrangement.

9. The cryogenic cleaning device of claim 1, wherein the cryogenic cleaning device is configured to reduce contamination in the vacuum chamber such that the vacuum chamber is configured to operate at high vacuum or higher.

10. A system comprising one or more cryogenic cleaning devices according to claim 1 and an analytical instrument comprising a vacuum chamber connected to the one or more cryogenic cleaning devices.

11. The system of claim 10, wherein the analytical instrument comprises a particle beam apparatus, the particle beam apparatus comprising one or more of: a scanning electron microscopy (SEM) arrangement, a focused ion beam (FIB) arrangement, an X-ray photoelectron spectroscopy (XPS) arrangement, and a transmission electron microscopy (TEM) arrangement.

12. The system of claim 10 further comprising an apparatus configured to bake the one or more cryogenic cleaning devices.

13. The system of claim 12, wherein the apparatus comprises one or more of: a resistive heating element, a radiative heating element and a conductive heating element.

14. The system of claim 10, wherein the pump comprises a pump of the analytical instrument configured to create a vacuum in the vacuum chamber of the analytical instrument.

15. The system of claim 10, wherein the vacuum chamber is configured to operate at high vacuum or higher.

16. The system of claim 10 further comprising a cold trap configured to be retractably attached to the vacuum chamber.

17. A method comprising steps of:
in a system comprising an analytical instrument and a cryogenic cleaning device connected to a vacuum chamber of the analytical instrument via a closeable fluid path, cooling a surface in a body of the cryogenic cleaning device using a single-stage refrigeration system to accumulate gas molecules received into the body via the fluid path on the cooled surface via condensation and/or adsorption;
after accumulating the gas molecules, closing the fluid path to prevent further gas molecules being received into the body; and
after closing the fluid path, baking and pumping out the cryogenic cleaning device to remove the gas molecules accumulated on the cooled surface from the cryogenic cleaning device.

18. The method of claim 17, further comprising a step of detachably connecting a cold trap to the vacuum chamber during cooling of the surface.

19. The method of claim 17, further comprising a step of detaching a cold trap from the vacuum chamber during baking and pumping out the cryogenic cleaning device.

20. The method of claim 17, wherein the system further comprises at least one additional cryogenic cleaning device connected to the vacuum chamber via an additional closeable fluid path, wherein during baking and pumping out of the cryogenic cleaning device, the method further comprises a step of cooling a surface in a body of the additional cryogenic cleaning device using an additional single-stage refrigeration component to accumulate gas molecules received into the body of the additional cryogenic cleaning device via the additional fluid path on the cooled surface via condensation and/or adsorption.
